(19) United States
(12) Patent Application Publication
(10) Pub. No.: US 2014/0100968 A1
(43) Pub. Date: Apr. 10, 2014

(54) DETERMINING BIDDER-AWARE VALUES FOR CONFIGURABLE AUCTION PARAMETERS

(71) Applicant: MICROSOFT CORPORATION, Redmond, WA (US)

(72) Inventors: MOSHE TENNENHOLTZ, Haifa (IS); HAIM SOMECH, Ramat Gan (IS); ROBERT PAUL GORMAN, Woodinville, WA (US); PENG HAN, Issaquah, WA (US); ERIK JON HANSON, Woodinville, WA (US); RON J. KARIDI, Herzeliya (IS); OMER LEVY, Ra'anana (IS)

(73) Assignee: MICROSOFT CORPORATION, Redmond, WA (US)

(21) Appl. No.: 13/647,142

(22) Filed: Oct. 8, 2012

(51) Int. Cl. G06Q 30/08

(52) U.S. Cl. 705/14.71

(57) ABSTRACT

Systems, methods, and computer-readable storage media are provided for determining configurable auction parameters based upon historic auction information that includes identities of auction participants or bidders. Such configurable auction parameters specify values to be applied for particular auction parameters (e.g., floor price), at the time of an auction for available advertising space, when one or more of the auction participants are associated with specified identities. Further provided are systems and methods for, at the time of an auction for available advertising space, determining auction parameter values in accordance with configurable auction parameters.

### BACKGROUND

Online markets are emerging at an amazing rate. One phenomenon occurring in such markets is that they run in a distributed manner. Namely, the market participants may show and the actual allocation of goods and pricing may be implemented in one part of the system, while configuring the market parameters, such as the actual parameters of the economic mechanism conducted, may be decided elsewhere. One example of such a market is an auction for available online advertising space conducted by an advertising exchange.

Most of the theory of auctions and market design assumes the existence of a quite concrete social context. That is, most of the literature assumes, for example, that the identity of auction participants (bidders) is known and optimization is done with regard to the given set of participants. Typically, there are probabilistic assumptions on the values of goods to participants. The practice of market design has, however, considered situations in which there is a lack of social awareness on the identity of participants. This is the situation, for instance, in the emerging exchange markets where floor price is used in second-price auctions to secure sales revenue and is applied per impression without knowing the identity of the auction participants or bidders.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In various embodiments, systems, methods, and computer-readable storage media are provided for, among other things, determining configurable auction parameters based upon historic auction information that includes identities of auction participants or bidders. Configurable auction parameters, in accordance with embodiments of the present invention, specify values to be applied for particular auction parameters (e.g., floor price), at the time of an auction for available advertising space, when one or more of the auction participants are associated with specified identities. Embodiments of the present invention further relate to, at the time of an auction for available advertising space, determining auction parameter values in accordance with the configurable auction parameters.

### BRIEF DESCRIPTION OF THE DRAWINGS

The present invention is illustrated by way of example and not limitation in the accompanying figures in which like reference numerals indicate similar elements and in which:

FIG. 1 is a block diagram of an exemplary computing environment suitable for use in implementing embodiments of the present invention;

FIG. 2 is a block diagram of an exemplary computing system in which embodiments of the invention may be employed;

FIG. 3 is a flow diagram showing an exemplary method for determining values for configurable online advertising auction parameters, in accordance with an embodiment of the present invention; and

FIG. 4 is a flow diagram showing an exemplary method for determining configurable auction parameters, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable storage media for, among other things, determining configurable auction parameters based upon historic auction information that includes identities of auction participants or bidders. In embodiments, an advertising exchange mechanism, which has access to historic auction information, provides at least a portion of such historic auction information to an online content publisher. Such historic auction information may include, by way of example only, identities associated with participants or bidders of historic auctions for available advertising space, identities of winning participants of historic auctions, winning bids associated with historic auctions, and/or non-winning bids associated with historic auctions. The online content publisher may analyze the provided historic auction information and determine one or more configurable auction parameters for use, for example, by the advertising exchange in conducting an auction for available advertising space on a webpage associated with the online content publisher. Configurable auction parameters, in accordance with embodiments of the present invention, specify values to be applied for particular auction parameters (e.g., floor price), at the time of an auction for available advertising space, when one or more of the auction participants are associated with specified identities. In embodiments, configurable auction parameters are provided as a vector or set of rules to be applied by an advertising exchange when specified conditions are met in a current auction for the online content publisher's available advertising space. Embodiments of the present invention further relate to, at the time of an auction for the online content publisher's available advertising space, determining auction parameter values in accordance with the configurable auction parameters.

Accordingly, one embodiment of the present invention is directed to one or more computer-readable storage media storing computer-useable instructions that, when used by one or more computing devices, cause the one or more computing devices to perform a method for determining values for configurable online advertising auction parameters. The method includes receiving, from an online content publisher (or a service or entity authorized to act on behalf of an online content publisher), at least one configurable auction parameter (e.g., floor price), the online content publisher having available advertising space, and the at least one configurable auction parameter being configurable based upon an identity of one or more participants (or bidders) in an auction for the available advertising space. The method further includes receiving, in the context of the auction for the available advertising space, bids from the one or more participants (or bidders) for the available advertising space, each of the one or more participants having an associated identity; and determining a value for the at least one configurable auction parameter based upon the associated identities of the one or more participants in the auction for the available advertising space.

In another embodiment, the present invention is directed to a system for determining values for configurable online advertising auction parameters. The system includes an advertising exchange mechanism having one or more processors and one or more computer-readable storage media, and a data store coupled with the advertising exchange mechanism. The advertising exchange mechanism is configured to provide (or direct an authorized service or entity to provide on its behalf) historic auction information to an online content publisher having available advertising space; receive, from the online content publisher, at least one auction parameter (e.g., floor price) that is configurable based upon an identity of one or more participants in an auction for the available advertising space; and conduct the auction for the available advertising space in accordance with the at least one auction parameter.

In yet another embodiment, the present invention is directed to a method being performed by one or more computing devices including at least one processor, for determining configurable auction parameters. The method includes receiving historic auction information from an advertising exchange, the historic auction information including identities associated with participants (or bidders) of historic auctions for available advertising space and, based at least on the identities associated with the participants of historic auctions for available advertising space, determining at least one configurable auction parameter (e.g., floor price). The at least one configurable auction parameter specifies a first value for the auction parameter if the associated identities of one or more participants in an auction for online advertising space include at least a first identity or group of identities, and the at least one configurable auction parameter specifies a second value for the auction parameter if the associated identities of one or more participants in the auction for online advertising space include at least a second identity or group of identities. In embodiments, the method further includes providing the at least one configurable auction parameter to an advertising exchange for use in determining which value to utilize for the at least one configurable auction parameter in the auction for available advertising space.

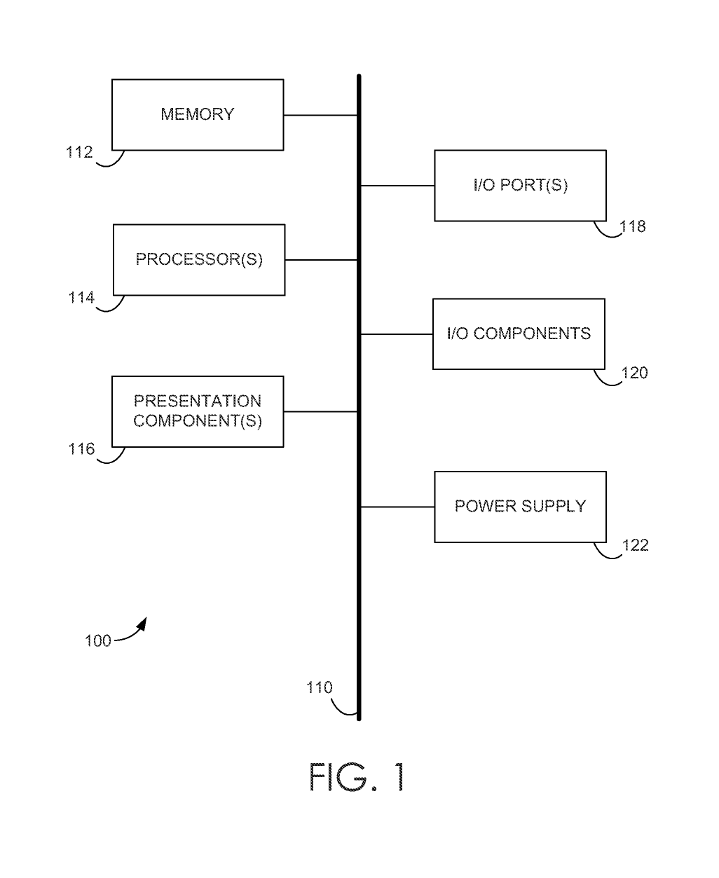

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one component nor any combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules including routines, programs, objects, components, data structures, and the like, and/or refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a storage device 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop.” “hand-held device,” etc., as all are contemplated within the scope of FIG. 1 and reference to “computing device.”

The computing device 100 typically includes a variety of computer-readable media. Computer-readable media may be any available media that can be accessed by the computing device 100 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer-readable media.

The storage device 112 includes computer-storage media in the form of volatile and/or nonvolatile memory. The storage device may be removable, non-removable, or a combination thereof. Exemplary hardware devices include solid-state memory, hard drives, optical-disc drives, and the like. The computing device 100 includes one or more processors that read data from various entities such as the storage device 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, and the like.

As previously mentioned, embodiments of the present invention are generally directed to systems, methods, and computer-readable storage media for, among other things, determining configurable auction parameters based upon historic auction information that includes identities of auction participants or bidders. In embodiments, an advertising exchange mechanism, which has access to historic auction information, provides at least a portion of such historic auction information to an online content publisher. Such historic auction information may include, by way of example only, identities associated with participants or bidders of historic auctions for available advertising space, identities of winning participants of historic auctions, winning bids associated with historic auctions, and/or non-winning bids associated with historic auctions. The online content publisher may analyze the provided historic auction information and determine one or more configurable auction parameters for use, for example, by the advertising exchange in conducting an auction for available advertising space on a webpage associated with the online content publisher. Configurable auction parameters, in accordance with embodiments of the present invention, specify values to be applied for particular auction parameters (e.g., floor price), at the time of an auction for available advertising space, when one or more of the auction participants are associated with specified identities. In embodiments, configurable auction parameters are provided as a vector or set of rules to be applied by an advertising exchange when specified conditions are met in a current auction for the online content publisher's available advertising space. Embodiments of the present invention further relate to, at the time of an auction for the online content publisher's available advertising space, determining auction parameter values in accordance with the configurable auction parameters.

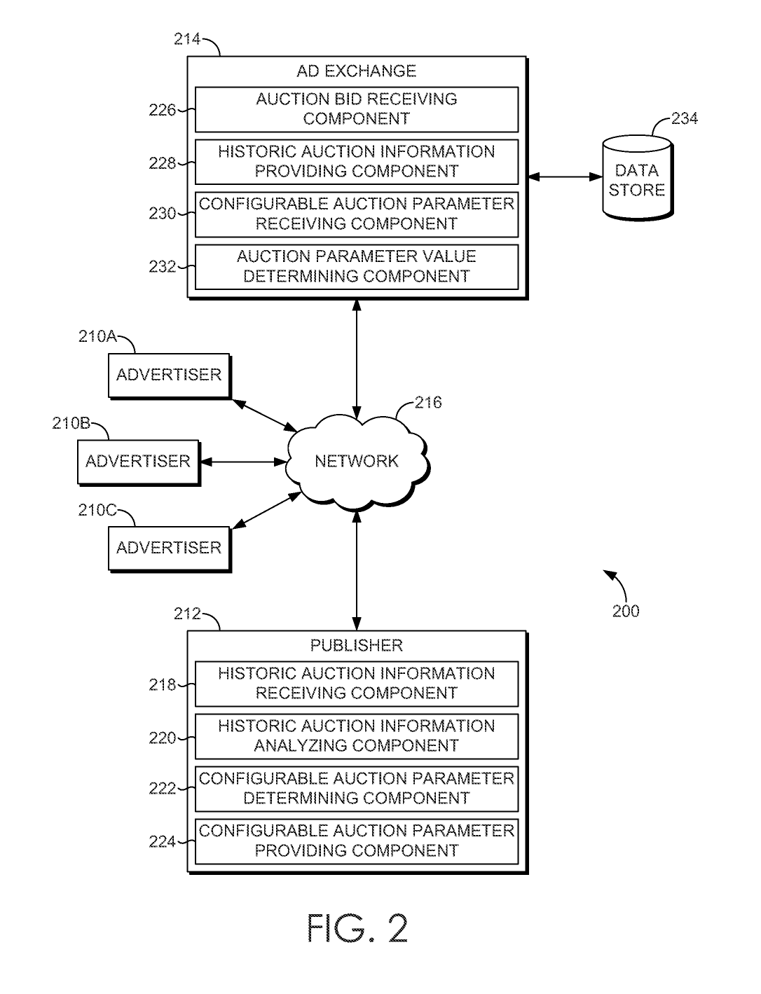

Referring now to FIG. 2, a block diagram is provided illustrating an exemplary computing system 200 in which embodiments of the present invention may be employed. Generally, the computing system 200 illustrates an environment in which configurable auction parameters may be determined based upon historic auction information that includes identities of auction participants and/or values for configurable auction parameters may be determined at the time of an auction for online advertising space. Among other components not shown, the computing system 200 generally includes a plurality of advertisers 210A, 210B, 210C, each associated with a computing device, a computing device associated with an online content publisher 212, and an advertising exchange mechanism 214, all in communication with one another via a network 216. The network 216 may include, without limitation, one or more local area networks (LANs) and/or wide area networks (WANs). Such networking environments are commonplace in offices, enterprise-wide computer networks, intranets and the Internet. Accordingly, the network 216 is not further described herein.

It should be understood that any number of advertiser computing devices, publisher computing devices and advertising exchange mechanisms may be employed in the computing system 200 within the scope of embodiments of the present invention. Each may comprise a single device/interface or multiple devices/interfaces cooperating in a distributed environment. For instance, the advertising exchange mechanism 214 may comprise multiple devices and/or modules arranged in a distributed environment that collectively provide the functionality of the advertising exchange mechanism 214 described herein. Additionally, other components/modules not shown also may be included within the computing system 200.

In some embodiments, one or more of the illustrated components/modules may be implemented as stand-alone applications. In other embodiments, one or more of the illustrated components/modules may be implemented via the advertiser computing device(s) 210A, 210B, 210C, as an Internet-based service, or as a module inside the publisher computing device 212 and/or the advertising exchange mechanism 214. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of advertiser computing devices, publisher computing devices, and/or computing devices associated with an advertising exchange mechanism. By way of example only, the advertising exchange mechanism 214 might be provided as a single computing device (as shown), a cluster of computing devices, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Each advertiser computing device 210A, 210B, 210B may include any type of computing device, such as the computing device 100 described with reference to FIG. 1, for example. Generally, each advertiser computing device 210A, 210B, 210C includes a bid input mechanism and a display. The bid input mechanism (not shown), among other things, is configured to receive advertiser input of bids for available online advertising space, as well as conditions associated with such bids (generally input via a user interface presented on the associated display and permitting alpha-numeric and/or textual input into a designated input area). The advertiser computing device(s) additionally is configured to receive information for presentation on the display, for instance, from the advertising exchange mechanism 214. It should be noted that the functionality described herein as being performed by the bid input mechanism/advertiser computing device(s) additionally may be performed by any application capable of rendering Web content. Any and all such variations, and any combination thereof, are contemplated to be within the scope of embodiments of the present invention.

The computing device associated with an online content publisher 212 of FIG. 2, is configured to receive historic auction information (e.g., from the advertising exchange mechanism 214), analyze the historic auction information, and determine configurable auction parameters in accordance therewith. Those skilled in the art of the present invention will recognize that embodiments of the present invention may be implemented with any number of online content publishers. Online content publishers are well known in the art and share many similar processes not further described herein.

As illustrated, the computing device associated with an online content publisher 212 includes an historic auction information receiving component 218, an historic auction information analyzing component 220, a configurable auction parameter determining component 222, and a configurable auction parameter providing component 224. The historic auction information receiving component 218 is configured to receive, for instance, from the advertising exchange mechanism 214 (as more fully described below), “historic auction information,” that is, information associated with past auctions for available advertising space. Such information may include, without limitation, identities associated with participants of historic auctions for available advertising space, identities of winning participants of historic auctions, winning bids associated with historic auctions, and/or non-winning bids associated with historic auctions. Generally, such information pertains to auctions for online advertising space associated with a webpage having the same or similar content to a webpage on which the online content publisher has available advertising space it desires to monetize. In embodiments, the content and volume of historic auction information received by the historic auction information receiving component 218 may vary depending upon properties desired for a given auction.

The historic auction information analyzing component 220 is configured to analyze the received historic auction information. Generally, such analysis is conducted off-line and is aimed at identifying patterns, trends, and/or characteristics of online auction participants that are desirable to the online content publisher associated with the computing device 212.

The configurable auction parameter determining component 222 is configured to determine one or more auction parameters that are configurable based upon the identities of the auction participants that ultimately bid on the online advertising space that the online content publisher desires to monetize. That is, “configurable auction parameters,” in accordance with embodiments of the present invention, specify values to be applied for particular auction parameters (e.g., floor price), at the time of the auction for the available online advertising space, when one or more of the auction participants are associated with specified identities. In embodiments, configurable auction parameters are provided as a vector or set of rules to be applied (for instance, by the advertising exchange mechanism 214) when specified conditions are met in a current auction for the online content publisher's available advertising space.

The configurable auction parameter providing component 224 is configured to provide the determined configurable auction parameters to the advertising exchange 214, e.g., via the network 216.

The advertising exchange mechanism 214 is configured to conduct auctions for online advertising space available from one or more online content publishers and, at the time of an auction, determine values for configurable auction parameters. Those skilled in the art of the present invention will recognize that embodiments of the present invention may be implemented with any number of advertising exchange mechanisms. Advertising exchange mechanisms are well known in the art and share many similar processes not further described herein

As illustrated, the advertising exchange mechanism 214 includes an auction bid receiving component 226, an historic auction information providing component 228, a configurable auction parameter receiving component 230, and an auction parameter value determining component. The auction bid receiving component 226 is configured to receive bids for available online advertising space (and any associated conditions), for instance, from one or more advertisers 210A, 210B, 210C. Utilizing the received bids, and in accordance with configurable auction parameters provided by one or more online content publishers, as more fully described below, the advertising exchange mechanism 214 is configured to conduct an online auction for the bid upon online advertising space.

The historic auction information providing component 228 is configured to provide historic auction information to one or more online content publishers, e.g., online content publisher 212. In this regard, the advertising exchange mechanism 214 has access to a data store 234. The data store 234 is configured to store information pertaining to auctions for online advertising space. In various embodiments, such information may include, without limitation, identities associated with participants or bidders of historic auctions for available advertising space, identities of winning participants of historic auctions, winning bids associated with historic auctions, and/or non-winning bids associated with historic auctions. The data store 234 further may be configured to store information pertaining to online content publishers and associated configurable auction parameters. In embodiments, the data store 234 is configured to be searchable for one or more of the items stored in association therewith. It will be understood and appreciated by those of ordinary skill in the art that the information stored in association with the data store 234 may be configurable and may include any information relevant to auctions for online advertising space. The content and volume of such information are not intended to limit the scope of embodiments of the present invention in any way. Further, though illustrated as a single, independent component, the data store 234 may, in fact, be a plurality of storage devices, for instance a database cluster, portions of which may reside in association with the advertising exchange mechanism 214, the online content publisher computing device 212, another external computing device (not shown), and/or any combination thereof. In embodiments, the content and volume of historic auction information provided by the historic auction information providing component 228 and/or stored in association with the data store 234 may vary depending upon properties desired for a given auction.

The configurable auction parameter receiving component 230 of the advertising exchange mechanism 214 is configured to receive configurable auction parameters, for instance, from the computing device associated with the online content publisher 212. In embodiments, such configurable auction parameters may be received as a vector or set of rules to be applied by the advertising exchange mechanism 214 when specified conditions are met in a current auction for the online content publisher's 212 available advertising space. In embodiments, such specified conditions pertain, at least in part, to the identity of one or more of the participants or bidders in a current auction for the online content publisher's available advertising space.

The auction parameter value determining component 232 is configured to determine a value for any configurable auction parameters at the time that the advertising exchange mechanism 214 conducts an auction for online advertising space. That is, the auction parameter value determining component 232 is configured to determine if any conditions or rules specified by a configurable auction parameter are satisfied and to determine a value for any such configurable auction parameters in accordance with the satisfied conditions or rules. Any determined values for configurable auction parameters may then be applied to the current auction and a winning bidder and winning bid amount (or lack thereof) may be determined.

In an embodiment of the present invention, information is available between the online content publisher 212, the advertiser(s) 210, and the ad exchange 214 in a distributed manner. That is, information about the identity of bidders participating in the auction is available to one party (e.g., the ad exchange) while information about the good (e.g., ad impression) is known to another party (the online content publisher 212), and the configurable floor price bridges these two together (e.g., is a vector of floor prices provided by the online content publisher 212 for different bidders' identity clusters, to be applied by the ad exchange 214 based on real-time information for the current bidders.

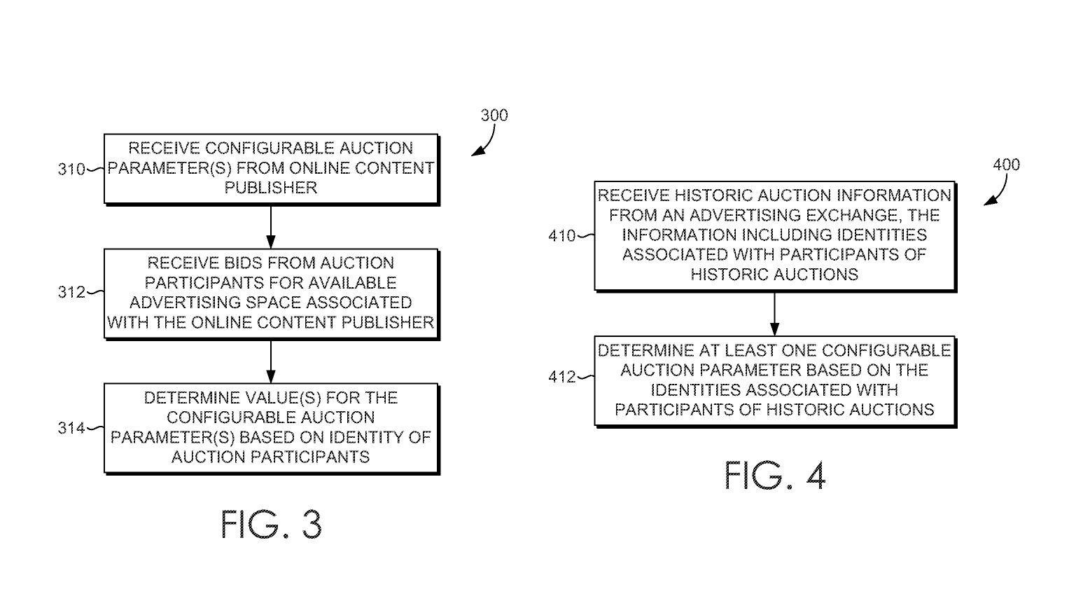

Turning now to FIG. 3, a flow diagram is illustrated showing an exemplary method 300 for determining values for configurable online advertising auction parameters, in accordance with an embodiment of the present invention. As indicated at block 310, at least one configurable auction parameter is received from an online content publisher having available advertising space that it desires to monetize. In embodiments, the at least one configurable auction parameter is configurable based upon an identity of one or more participants or bidders in a current auction for the available advertising space. As indicated at block 312, bids are received, in an auction for the available advertising space associated with the online content publisher, from one or more participants or bidders (e.g., advertisers). In embodiments, each of the one or more participants is associated with an identity. A value is determined for the at least one configurable auction parameter based, at least in part, upon the associated identities of the one or more participants (bidders) in the auction for the available advertising space. This is indicated at block 314.

With reference to FIG. 4, shown is a flow diagram illustrating another exemplary method 400 for determining configurable auction parameters, in accordance with an embodiment of the present invention. As indicated at block 410, historic auction information is received from an advertising exchange, for instance, by an online content publisher having available advertising space. The historic auction information includes, at least, identities associated with participants (e.g., advertisers) of historic auctions for available advertising space. As indicated at block 412, based at least one on the identities associated with participants of historic auctions for available advertising space, at least one configurable auction parameter is determined. In embodiments, the at least one configurable auction parameter specifies a first value for the auction parameter if the associated identities of one or more participants in an auction for online advertising space include at least a first identity or group of identities, and the at least one configurable auction parameter specifies a second value for the auction parameter if the associated identities of one or more participants in the auction for online advertising space include at least a second identity or group of identities.

As can be understood, embodiments of the present invention provide systems and methods for determining configurable auction parameters based upon historic auction information that includes identities of auction participants or bidders. Configurable auction parameters, in accordance with embodiments of the present invention, specify values to be applied for particular auction parameters (e.g., floor price), at the time of an auction for available advertising space, when one or more of the auction participants are associated with specified identities. Embodiments of the present invention further provide, at the time of an auction for available advertising space, determining auction parameter values in accordance with the configurable auction parameters.

The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the methods 300 of FIGS. 3 and 400 of FIG. 4 is not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. One or more computer-readable storage media storing computer-useable instructions that, when used by one or more computing devices, cause the one or more computing devices to perform a method for determining values for configurable online advertising auction parameters, the method comprising:
receiving, from an online content publisher, at least one configurable auction parameter, the online content publisher having available advertising space, and the at least one configurable auction parameter being configurable based upon an identity of one or more participants in an auction for the available advertising space;
receiving, in the auction for the available advertising space, bids from the one or more participants for the available advertising space, each of the one or more participants having an associated identity; and
determining a value for the at least one configurable auction parameter based upon the associated identities of the one or more participants in the auction for the available advertising space.

2. The one or more computer-readable storage media of claim 1, wherein the at least one configurable auction parameter is a floor price.

3. The one or more computer-readable storage media of claim 1, wherein the at least one configurable auction parameter is provided as a vector.

4. The one or more computer-readable storage media of claim 1, wherein the method further comprises providing historic auction information to the online content publisher prior to receiving the at least one configurable auction parameter.

5. The one or more computer-readable storage media of claim 4, wherein the historic auction information includes identities associated with participants of historic auctions for available advertising space.

6. The one or more computer-readable storage media of claim 5, wherein the historic auction information further includes one or more of identities of winning participants of historic auctions, winning bids associated with historic auctions, and non-winning bids associated with historic auctions.

7. The one or more computer-readable storage media of claim 1, wherein the value for the at least one configurable auction parameter is determined to be a first value for each of the one or more participants in the auction for the available advertising space if the associated identities of the one or more participants in the auction include at least a first identity or group of identities specified by the configurable auction parameter, and wherein the value for the at least one configurable auction parameter is determined to be a second value for each of the one or more participants in the auction for the available advertising space if the associated identities of the one or more participants in the auction include at least a second identity or group of identities specified by the configurable auction parameter.

8. The one or more computer-readable storage media of claim 1, wherein the auction is a second-price auction.

9. A system for determining values for configurable online advertising auction parameters, the system comprising:
an advertising exchange mechanism having one or more processors and one or more computer-readable storage media; and
a data store coupled with the advertising exchange mechanism,
wherein the advertising exchange mechanism:
provides historic auction information to an online content publisher having available advertising space;
receives, from the online content publisher, at least one auction parameter that is configurable based upon an identity of one or more participants in an auction for the available advertising space; and
conducts the auction for the available advertising space in accordance with the at least one auction parameter.

10. The system of claim 9, wherein the system conducts the auction for the available advertising space by:
receiving bids from a plurality of auction participants, each of the plurality of auction participants having an associated identity; and
determining a value for the at least one configurable auction parameter based upon the associated identity of at least one of the plurality of participants in the auction for the available advertising space.

11. The system of claim 9, wherein the at least one configurable auction parameter is a floor price.

12. The system of claim 9, wherein the historic auction information includes identities associated with participants of historic auctions for available advertising space.

13. The system of claim 12, wherein the historic auction information further includes one or more of an identity of winning participants of historic auctions, winning bids associated with historic auctions, and non-winning bids associated with historic auctions.

14. The system of claim 13, wherein the value for the at least one configurable auction parameter is determined to be a first value for each of the one or more participants in the auction for the available advertising space if the associated identities of the one or more participants in the auction include at least a first identity or group of identities specified by the configurable auction parameter, and wherein the value for the at least one configurable auction parameter is determined to be a second value for each of the one or more participants in the auction for the available advertising space if the associated identities of the one or more participants in the auction include at least a second identity or group of identities specified by the configurable auction parameter.

15. The system of claim 9, wherein the auction for the available advertising space is a second-price auction.

16. A method being performed by one or more computing devices including at least one processor, for determining configurable auction parameters, the method comprising:
receiving historic auction information from an advertising exchange, the historic auction information including identities associated with participants of historic auctions for available advertising space; and
based at least on the identities associated with the participants of historic auctions for available advertising space, determining at least one configurable auction parameter, wherein the at least one configurable auction parameter specifies a first value for the auction parameter if the associated identities of one or more participants in an auction for online advertising space include at least a first identity or group of identities, and wherein the at least one configurable auction parameter specifies a second value for the auction parameter if the associated identities of one or more participants in the auction for online advertising space include at least a second identity or group of identities.

17. The method of claim 16, wherein the at least one configurable auction parameter is a floor price.

18. The method of claim 16, wherein the historic bid information further includes one or more of an identity of winning participants of historic auctions, winning bids associated with historic auctions, and non-winning bids associated with historic auctions.

19. The method of claim 16, further comprising providing the at least one configurable auction parameter to an advertising exchange for use in determining which value to utilize for the at least one configurable auction parameter in the auction for available advertising space.

20. The method of claim 16, wherein the auction for online advertising space is a second-price auction.
